(19) United States
(12) Patent Application Publication
(10) Pub. No.: US 2005/0013396 A1
(43) Pub. Date: Jan. 20, 2005

(54) Digital clock recovery circuit employing fixed clock oscillator driving fractional delay line

(75) Inventors: Matthew A. Kliesner, Madison, AL (US); Timothy G. Mester, Madison, AL (US); Eric M. Rives, Hampton Cove, AL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ADTRAN, INC., HUNTSVILLE, AL (US)

(21) Appl. No.: 10/620,151

(22) Filed: Jul. 15, 2003

(51) Int. Cl. H04L 7/00

(52) U.S. Cl. 375/372; 375/373

(57) ABSTRACT

A clock recovery scheme for a digital communication receiver has a fixed fractional delay line that is driven by a fixed frequency reference clock source, to provide a plurality of respectively offset phase delayed versions of the reference clock. A phase lock loop, to which the received signal is coupled, controllably steps through the phase delayed versions of the reference clock, so as to controllably increase or decrease the effective frequency of the reference clock and thereby produce a recovered clock signal.

### FIELD OF THE INVENTION

The present invention relates in general to communication systems and subsystems therefor, and is particularly directed to a clock recovery scheme for a digital communication receiver. The clock recovery scheme employs a fixed fractional delay line that is driven by a fixed reference clock source, to provide a plurality of respectively offset phase delayed versions of the reference clock. One of the phase delayed versions of the reference clock is used as the recovered clock. A control loop steps through the outputs of the fixed fractional delay line, so as to controllably increase or decrease the effective frequency of the reference clock and thereby adjust the frequency of the recovered clock signal.

### BACKGROUND OF THE INVENTION

In order to successfully coherently recover data from a received digital communication signal, digital communication receivers employ some form of clock recovery or extraction mechanism that operates on the received signal. A conventional variable frequency oscillator-based scheme employed for this purpose is diagrammatically illustrated in FIG. 1 as comprising a phase detector 10, to which a received (RX) signal 11 and the output 13 of a variable frequency oscillator (VFO) 12 are applied. The output of the phase detector 10, which represents the phase error between the received signal 11 and the output of the VFO is coupled through a loop filter 14 to the control input of the VFO 12. The recovered clock corresponds to the output frequency of the VFO.

A shortcoming of this type of clock recovery scheme is the sensitivity and expense of the variable frequency oscillator, which is typically a crystal-based component, whose parameters may vary depending upon its manufacturer. In addition, where the receiver is employed in a relatively harsh environment, the oscillator is prone to substantial operational variation and degradation.

### SUMMARY OF THE INVENTION

In accordance with the present invention, the above and other problems associated with using a variable frequency oscillator-based clock recovery circuit are effectively obviated by a clock recovery scheme that employs a fixed fractional delay line coupled to the output of a fixed frequency oscillator, the frequency of which is nominally that of the received signal. The delay line has a plurality of output ports from which respective incrementally delayed versions of the fixed clock frequency. Namely, the delay line produces N clock signals having successive delays (0/N)360, (1/N)360, . . . , ((N−1)/N)360 degrees relative to its input clock.

These N clock signals are respectively coupled to N input ports of a multiplexer, the output of which produces the recovered clock signal. The multiplexer output is further coupled to a phase detector/comparator of a feedback loop to which the received signal is applied. The output of the phase detector/comparator represents the error between the recovered clock and the received data signal, and is coupled through a loop filter and gain stage to a frequency accumulator. The gain is set so that the accumulator overflows when the difference frequency f_{d} between the received data clock f_{R} and frequency f_{N} is a prescribed value, so that the output of the frequency accumulator indicates whether the recovered clock is running faster or slower than the clock embedded in the received data signal.

Where the output clock is running faster than the received signal, the state of the accumulator will cause the multiplexer to incrementally advance or step in a first, increased delay direction through the plurality of output ports of the delay line. This has the effect of lengthening a portion of one of the half-cycles of the output/recovered clock signal, thereby slowing down the recovered clock. On the other hand, where the output clock is running slower than the received signal, the state of the accumulator will cause the multiplexer to incrementally step through the output ports of the delay line in a reverse direction. This has the effect of shortening a portion of one of the half-cycles of the output/recovered clock signal, thereby speeding up the recovered clock.

### BRIEF DESCRIPTION OF THE DRAWINGS

FIG. 1 diagrammatically illustrates a conventional variable frequency oscillator-based clock recovery circuit for use with a digital communication receiver;

FIG. 2 diagrammatically illustrates an embodiment of the fixed fractional delay line-based clock recovery circuit of the present invention;

FIG. 3 is a timing diagram showing the effect of lengthening a portion of a clock cycle of the reference clock signal of the circuit of FIG. 2, so as to slow down the recovered clock; and

FIG. 4 is a timing diagram showing the effect of shortening a portion of a clock cycle of the reference clock signal of the circuit of FIG. 2, so as to speed up the recovered clock.

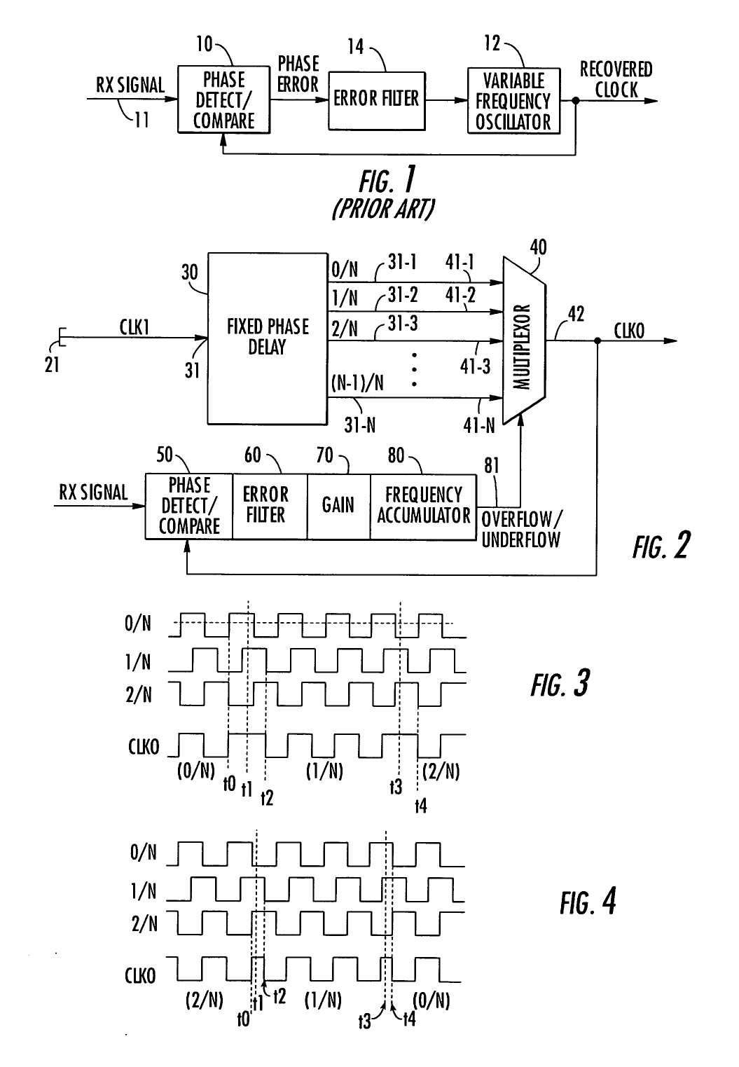

### DETAILED DESCRIPTION

Before describing the fixed fractional delay line-based clock recovery circuit in accordance with the present invention, it should be observed that the invention resides primarily in a modular arrangement of conventional digital communication circuits and components. In a practical implementation that facilitates their being packaged in a hardware-efficient equipment configuration, these modular arrangements may be readily implemented as field programmable gate array (FPGA), or application specific integrated circuit (ASIC) chip sets.

Consequently, the configuration of such arrangements of circuits and components and the manner in which they are interfaced with other telecommunication equipment have, for the most part, been illustrated in the drawings by readily understandable block diagrams, and associated timing diagrams, which show only those specific details that are pertinent to the present invention, so as not to obscure the disclosure with details which will be readily apparent to those skilled in the art having the benefit of the description herein. The block diagram illustrations are primarily intended to show the major components of the clock recovery circuit of the invention in a convenient functional grouping, whereby the present invention may be more readily understood. For purposes of providing a non-limiting example, a receiver architecture in which the clock recovery circuit of the invention may be employed may comprise a baseband modem receiver for a wireline-powered digital radio, such as that disclosed in U.S. Pat. No. ______ to P. Nelson et al, assigned to the assignee of the present application and the disclosure of which is incorporated herein.

Attention is now directed to FIG. 2, wherein an embodiment of the fixed fractional delay line-based clock recovery circuit of the present invention is diagrammatically illustrated as comprising a clock input port 21, to which a fixed frequency input clock signal CLKI at some nominal frequency f_{N} is applied. In the example of the radio disclosed in the above-referenced patent, the fixed frequency clock may be derived from the transmit clock employed in the transmit portion of the radio. Clock input port 21 is coupled to an input 31 of a fixed phase delay line 30, which has a plurality of output ports 32-1, 32-2, 31-3, . . . , 32-N, from which respective incrementally delayed versions of the fixed clock frequency f_{N} are produced. Namely, delay line 30 is operative to produce N clock signals having successive delays (0/N)360, (1/N)360, . . . , ((N−1)/N)360 degrees relative to the input clock supplied to the clock input port 21.

These N clock signals are respectively coupled to N input ports 41-1, 41-2, 41-3, . . . , 41-N of a multiplexer 40, an output port 42 of which produces the recovered or output clock signal CLKO. Output port 42 is further coupled to a phase detector/comparator 50 to which the received (RX) signal is applied. The output of the phase detector/comparator 50, which represents the error between the recovered clock and the received data signal, is coupled through a loop filter 60 and gain stage 70 for application to a frequency accumulator 80. The gain is set so that the accumulator 80 overflows when the difference frequency f_{d} between the received data clock f_{R} and frequency f_{N} is a prescribed value. Namely, the output of the frequency accumulator 80 indicates whether the recovered clock is running faster or slower than the clock embedded in the received data signal.

Where the output clock CLKO is running faster than the received signal RX, the state of the overflow/underflow output 81 of the accumulator 80 will cause the multiplexer 30 to incrementally advance or step through the plurality of output ports 32-1, 32-2, . . . , 32-N of the delay line 20. As will be described below with reference to the timing diagram of FIG. 3, this has the effect of lengthening one of the half-cycles of the output/recovered clock signal, thereby slowing down the recovered clock. On the other hand, where the output clock CLKO is running slower than the received signal RX, the state of overflow/underflow output 81 of the accumulator 80 will cause the multiplexer 30 to incrementally reverse through the plurality of output ports 32-1, 32-2, . . . , 32-N of the delay line 20. As will be described below with reference to the timing diagram of FIG. 4, this has the effect of shortening one of the half-cycles of the output/recovered clock signal, thereby speeding up the recovered clock.

More particularly, FIG. 3 shows a set of three phase delayed versions of the fixed input clock signal CLKI as produced at output ports 32-1, 32-2, . . . , 32-N of the fraction delay line 30, where N=4. Since N=4, each successive version of the input clock signal is delayed by 90° relative to its immediately preceding version of the input clock signal. It will be assumed that the multiplexer is initially reset to couple its first input port 41-1 to its output port 42, and that the output clock CLKO is running faster than the embedded clock in the received signal. It will also be assumed that the clock signal adjustment occurs once for every three successive clock cycles. Since multiplexer 40 ‘points’ to its input port 41-1, then at time t0, the rising edge of the output clock CLKO coincides with the rising edge of the input clock version having the phase delay (0/N)360.

At time t1, the frequency accumulator 80 produces an output associated with an overflow condition. For this state of the accumulator output, multiplexer 40 responds by incrementing the connection of the output port 42 to the second input port 42-2. Since, at time t1, the high state of the input clock version having the phase delay (1/N)360 is the same as that (high) as the input clock version having the phase delay (0/N)360, the state of the output clock is high and remains high for an additional period of time, to coincide with the clock version having phase delay (1/N)360, which transitions low at time t2. Namely, due to the incrementing of the fixed phase delayed versions of the fixed input clock, the output clock has been lengthened or has slipped by a fraction (here 90°) of the clock cycle of the input clock.

With the clock signal adjustment occurring once for every three successive clock cycles, then at time t3 in the timing diagram of FIG. 3, there is a further incremental advancing or stepping from the input clock version having the phase delay (1/N)360 to the next input clock version, namely input clock version having the phase delay (2/N)360. As shown therein, at time t3, the high state of the input clock version having the phase delay (2/N)360 is again the same as that (high) as the input clock version having the phase delay (1/N)360, so that the state of the output clock is high and remains high for an additional period of time, to coincide with the clock version having phase delay (2/N)360, which transitions low at time t4. Thus, due to the further incrementing of the fixed phase delayed versions of the fixed input clock, the output clock CLKO is again lengthened or slipped by a 90° fraction of the clock cycle of the input clock. It will be appreciated that for the example shown in the timing diagram of FIG. 3, such slipping or lengthening of the output clock effectively reduces the frequency of the output clock CLKO to 12/13 of its original frequency.

The timing diagram of FIG. 4 shows the same set of three phase delayed versions of the fixed input clock signal CLKI as produced at output ports 32-1, 32-2, . . . , 32-N of the fraction delay line 30, again with N=4. It will be assumed that the multiplexer 40 is initially pointing to input port 41-3, so that at time t0, the rising edge of the output clock CLKO coincides with the rising edge of the input clock version having the phase delay (2/N)360.

At time t1, the frequency accumulator 80 produces an output associated with an underflow condition. For this state of the accumulator output, multiplexer 40 responds by decrementing the connection of the output port 42 to the second input port 42-2. Since, at time t1, the high state of the input clock version having the phase delay (1/N)360 is the same as that (high) as the input clock version having the phase delay (2/N)360, the state of the output clock is initially high, but then transitions low at time t2, to coincide with falling edge of the clock version having phase delay (1/N)360, which transitions low at time t2. Namely, due to the decrementing of the fixed phase delayed versions of the fixed input clock, the output clock has been shortened or advanced by a fraction (here 90°) of the clock cycle of the input clock.

With the clock signal adjustment occurring once for every three successive clock cycles, then at time t3 in the timing diagram of FIG. 3, there is a further decrementing from the input clock version having the phase delay (1/N)360 to the input clock version having the phase delay (0/N)360. Namely, due to the further decrementing of the fixed phase delayed versions of the fixed input clock, the output clock has been shortened or advanced by a fraction (here 90°) of the clock cycle of the input clock. For the example shown in the timing diagram of FIG. 4, advancing the output clock effectively increases the frequency of the output clock CLKO to 12/11 of its original frequency.

As will be appreciated from the foregoing description, problems associated with using a variable frequency oscillator-based, clock recovery circuit are effectively obviated by the fixed fractional delay line-based clock recovery scheme of the present invention. Where the output clock is running faster than the received signal, the state of the accumulator will cause the multiplexer to incrementally advance or step through the plurality of output ports of the delay line in a first increased delay direction, which effectively lengthens a portion of a half-cycle of the output/recovered clock signal, thereby slowing down the recovered clock. Where the output clock is running slower than the received signal, the state of the accumulator will cause the multiplexer to incrementally reverse through the output ports of the delay line, in a decreasing delay direction, which has the effect of shortening a portion of a half-cycle of the recovered clock signal, thereby speeding up the recovered clock.

While we have shown and described an embodiment in accordance with the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art.

1. A method of deriving an output clock signal from a received data signal comprising the steps of:
(a) coupling a fixed frequency input clock signal to a multitap delay line, having outputs that provide respectively different phase delayed versions of said fixed frequency input clock signal;
(b) coupling one of said outputs of said multitap delay line to an output port from which said output clock signal is derived; and
(c) controllably coupling another of said outputs of said multitap delay line to said output port so as to change said output clock signal in accordance with a relationship between said received data signal and said output clock signal.

2. The method according to claim 1, wherein step (c) comprises controllably coupling to said output port an output of said multitap delay line that provides a later-in-time delay relative to said one of said outputs of said multitap delay line, in response to said output clock signal exhibiting a clock frequency that is higher than the frequency of said received data signal, thereby reducing the frequency of said output clock signal.

3. The method according to claim 1, wherein step (c) comprises controllably coupling to said output port an output of said multitap delay line that provides an earlier-in-time delay relative to said one of said outputs of said multitap delay line, in response to said output clock signal exhibiting a clock frequency that is lower than the frequency of said received data signal, thereby increasing the frequency of said output clock signal.

4. The method according to claim 1, wherein step (c) comprises phase-comparing said received data signal with said output clock signal to derive a phase error signal, and controllably coupling another of said outputs of said multitap delay line to said output port so as to change said output clock signal in accordance with whether said received data signal is advanced or retarded relative to said output clock signal.

5. The method according to claim 1, wherein step (c) comprises phase-comparing said received data signal with said output clock signal to derive a phase error signal, and periodically, over an interval of plural cycles of said output clock signal, coupling another of said outputs of said multitap delay line to said output port so as to change said output clock signal in accordance with whether said received data signal is advanced or retarded relative to said output clock signal.

6. An apparatus for deriving an output clock signal from a received data signal comprising:
a multitap delay line, to which a fixed frequency input clock signal is applied, said multitap delay line having a plurality of outputs that provide respectively different phase delayed versions of said fixed frequency input clock signal;
a multiplexer having a plurality of inputs respectively coupled to said plurality of outputs of said multitap delay line, and being controllably operative to couple one of said outputs of said multitap delay line to an output port from which said output clock signal is derived; and
a control circuit, which is operative to selectively change which of said outputs of said multitap delay line is coupled by said multiplexer to said output port, so as to controllably change said output clock signal in accordance with a relationship between said received data signal and said output clock signal.

7. The apparatus according to claim 6, wherein said control circuit is operative to cause said multiplexer to controllably couple said output port to an output of said multitap delay line that provides a later-in-time delay relative to said one of said outputs of said multitap delay line, in response to said output clock signal exhibiting a clock frequency that is higher than the frequency of said received data signal, thereby reducing the frequency of said output clock signal.

8. The apparatus according to claim 6, wherein said control circuit is operative to cause said multiplexer to controllably couple said output port to an output of said multitap delay line that provides an earlier-in-time delay relative to said one of said outputs of said multitap delay line, in response to said output clock signal exhibiting a clock frequency that is lower than the frequency of said received data signal, thereby increasing the frequency of said output clock signal.

9. The apparatus according to claim 6, wherein said control circuit is operative to phase-compare said received data signal with said output clock signal to derive a phase error signal, and to cause said multiplexer to controllably couple another of said outputs of said multitap delay line to said output port so as to change said output clock signal in accordance with whether said received data signal is advanced or retarded relative to said output clock signal.

10. The apparatus according to claim 6, wherein said control circuit is operative to phase-compare said received data signal with said output clock signal to derive a phase error signal, and to periodically cause, over an interval of plural cycles of said output clock signal, said multiplexer to couple another of said outputs of said multitap delay line to said output port so as to change said output clock signal in accordance with whether said received data signal is advanced or retarded relative to said output clock signal.

11. An apparatus for deriving an output clock signal from a received data signal comprising:
a fixed fractional delay line having an input port coupled to receive a fixed frequency input clock signal, said fixed fractional delay line having a plurality of outputs that provide respectively different phase delayed versions of said fixed frequency input clock signal;
a multiplexer having a plurality of inputs respectively coupled to said plurality of outputs of said fixed fractional delay line, and being controllably operative to couple one of said outputs of said fixed fractional delay line to an output port from which said output clock signal is derived; and
a control loop, coupled between the output and a steering control input of said multiplexer circuit, and being operative to selectively change which of said outputs of said fixed fractional delay line is coupled by said multiplexer to said output port, so as to controllably change said output clock signal in accordance with a relationship between said received data signal and said output clock signal.

12. The apparatus according to claim 11, wherein said control loop is operative to cause said multiplexer to controllably couple said output port to an output of said fixed fractional delay line that provides a later-in-time delay relative to said one of said outputs of said fixed fractional delay line, in response to said output clock signal exhibiting a clock frequency that is higher than the frequency of said received data signal, thereby reducing the frequency of said output clock signal.

13. The apparatus according to claim 11, wherein said control loop is operative to cause said multiplexer to controllably couple said output port to an output of said fixed fractional delay line that provides an earlier-in-time delay relative to said one of said outputs of said fixed fractional delay line, in response to said output clock signal exhibiting a clock frequency that is lower than the frequency of said received data signal, thereby increasing the frequency of said output clock signal.

14. The apparatus according to claim 11, wherein said control loop is operative to phase-compare said received data signal with said output clock signal to derive a phase error signal, and to cause said multiplexer to controllably couple another of said outputs of said fixed fractional delay line to said output port so as to change said output clock signal in accordance with whether said received data signal is advanced or retarded relative to said output clock signal.

15. The apparatus according to claim 11, wherein said control loop is operative to phase-compare said received data signal with said output clock signal to derive a phase error signal, and to periodically cause, over an interval of plural cycles of said output clock signal, said multiplexer to couple another of said outputs of said fixed fractional delay line to said output port so as to change said output clock signal in accordance with whether said received data signal is advanced or retarded relative to said output clock signal.
